(19) United States
(12) Patent Application Publication
(10) Pub. No.: US 2026/0350896 A1
(43) Pub. Date: Nov. 5, 2026

(54) DATA PROCESSING METHOD, DEVICE, AND STORAGE MEDIUM

(71) Applicant: Beijing Zitiao Network Technology Co., Ltd., Beijing (CN)

(72) Inventors: Zichao WEI, Beijing (CN); Tingshuo CHEN, Beijing (CN); Yuan ZENG, Beijing (CN); Zhaojun LING, Beijing (CN)

(21) Appl. No.: 19/664,492

(22) Filed: Apr. 30, 2026

(30) Foreign Application Priority Data
Apr. 30, 2025 (CN) 202510571842.0

(51) Int. Cl. G06T 13/20; G06T 13/40; G10L 13/033; G10L 13/04; G10L 15/02; G10L 15/22; G10L 15/30; G10L 25/63; H04N 13/302

(52) U.S. Cl. CPC G06T 13/205; G06T 13/40; G10L 13/033; G10L 13/04; G10L 15/02; G10L 15/22; G10L 15/30; G10L 25/63; H04N 13/302

(57) ABSTRACT

Provided are a data processing method and apparatus, a device, a medium and a product in the field of Internet technologies. The method includes: after a client receives a first speech (such as a speech describing a user question) input by a user, the client performs speech recognition on the first speech to obtain a first text (such as a text describing the user question), and sends the first text to a server; and after the client receives a second speech, an expression sequence and an action sequence that are sent by the server, the client generates an image sequence on the basis of the expression sequence and the action sequence, and the client plays the second speech and displays the image sequence. In this way, the client may automatically answer the user question, thereby reducing the cost of answering and improving user experience.

### CROSS-REFERENCE TO RELATED APPLICATIONS

The present application is based on and claims priority to Chinese Patent Application No. 202510571842.0, and filed on Apr. 30, 2025, the entire disclosure of the Chinese Patent Application is hereby incorporated by reference in its entirety.

### TECHNICAL FIELD

The present disclosure relates to the field of Internet technologies, and in particular, to a data processing method and apparatus, a device, a medium, and a product.

### BACKGROUND

For some scenarios, these scenarios have the following requirements: answering questions raised by users, in order to solve the doubts of the users. In order to meet the above requirements, a relevant person may interact with a user to answer a question raised by the user.

### SUMMARY

The present disclosure provides a data processing method and apparatus, a device, a medium, and a product.

In order to achieve the above object, the technical solutions provided in the present disclosure are as follows:

The present disclosure provides a data processing method. The method is applied to a client, and the method includes: receiving a first speech, performing speech recognition on the first speech to obtain a first text, and sending the first text to a server; receiving a second speech, an expression sequence, and an action sequence that are sent by the server, where the second speech indicates speech content of a virtual character when replying to the first speech, the expression sequence indicates expression changes of the virtual character when replying to the first speech, and the action sequence indicates action changes of the virtual character when replying to the first speech; generating an image sequence based on the expression sequence and the action sequence, where the image sequence describes changes of the virtual character in at least one dimension, and the at least one dimension includes an expression and/or an action; and playing the second speech and displaying the image sequence.

The present disclosure provides a data processing method. The method is applied to a server, and the method includes: receiving a first text sent by a client, determining a second text based on the first text, and generating a second speech based on the second text; determining an action sequence based on the second speech and the second text, and predicting an expression sequence based on the second speech; and sending the second speech, the expression sequence, and the action sequence to the client.

The present disclosure provides an electronic device. The device includes: a processor and a memory, where the memory is configured to store an instruction or a computer program, and the processor is configured to execute the instruction or the computer program in the memory to cause the electronic device to perform the data processing method provided in the present disclosure.

The present disclosure provides a computer-readable medium having an instruction or a computer program stored thereon, where the instruction or the computer program, when executed by a device, causes the device to perform the data processing method provided in the present disclosure.

The present disclosure provides a computer program product including a computer program carried on a non-transitory computer-readable medium, where the computer program includes program codes for performing the data processing method provided in the present disclosure.

Compared with the related art, the present disclosure has at least the following advantages.

### BRIEF DESCRIPTION OF THE DRAWINGS

In order to more clearly explain the technical solutions in the embodiments of the present disclosure or in the related art, the following briefly introduces the drawings required for describing the embodiments or the related art. Apparently, the drawings in the following description show merely some embodiments of the present disclosure, and a person of ordinary skill in the art may still derive other drawings from these drawings without paying creative efforts.

FIG. 1 is a flowchart of a data processing method applied to a client according to an embodiment of the present disclosure;

FIG. 2 is a schematic diagram of a data processing procedure in a question answering scenario according to an embodiment of the present disclosure;

FIG. 3 is a schematic diagram of a complete round of conversation according to an embodiment of the present disclosure;

FIG. 4 is a schematic diagram of a state machine according to an embodiment of the present disclosure;

FIG. 5 is a schematic diagram of a cyclic procedure of state switching according to an embodiment of the present disclosure;

FIG. 6 is a schematic diagram of a data processing procedure in an automatic broadcast scenario according to an embodiment of the present disclosure;

FIG. 7 is a flowchart of a data processing method applied to a server according to an embodiment of the present disclosure;

FIG. 8 is a schematic structural diagram of a data processing apparatus according to an embodiment of the present disclosure;

FIG. 9 is a schematic structural diagram of another data processing apparatus according to an embodiment of the present disclosure; and

FIG. 10 is a schematic structural diagram of an electronic device according to an embodiment of the present disclosure.

### DETAILED DESCRIPTION OF EMBODIMENTS

Currently, in order to meet the above requirements of answering questions raised by users, a relevant person may interact with a user to answer a question raised by the user. However, in this solution, the user needs to learn a large amount of content in advance, the cost of answering in this solution is relatively high.

Research has found that in order to reduce costs, an automatic answering service may be provided to users through some technologies (such as a machine learning model and other technologies), in order to reduce the cost of answering and improve user experience.

Research has also found that although the above automatic answering service may improve user experience in some aspects, the automatic answering service has at least the defects \textcircled{1} and \textcircled{2} shown hereinafter, so that many users prefer to question and answer manually.
\textcircled{1} The service capability is poor, the reason is: the above automatic answering service replies to user's questions based on preset question and answer pairs, so that the automatic answering service cannot flexibly analyze and give effective suggestions (or replies) for questions with certain variations proposed by users and temporary requirements proposed by users.
\textcircled{2} The emotional expression is insufficient, the reason is: the above automatic answering service lacks emotion when answering, which results in that users cannot vividly communicate and empathize with the automatic answering service, thus affecting user experience.

Based on the above research, in order to better improve user experience, the present disclosure provides a data processing method applied to a client. The method includes: for a client that may interact with a user, after the client receives a first speech (such as a speech describing a question from the user) input by the user, the client first performs speech recognition on the first speech to obtain a first text (such as a text describing the question from the user), and sends the first text to a server, so that the server may process and feed back the first text, after the client receives a second speech, an expression sequence, and an action sequence that are sent by the server, the client generates an image sequence based on the expression sequence and the action sequence, and the client plays the second speech and displays the image sequence, so that the client may automatically answer the question from the user, thereby reducing the cost of answering. The expression sequence may indicate expression changes of a virtual character when replying to the first speech, and the action sequence may indicate action changes of the virtual character when replying to the first speech, so that the image sequence generated based on the expression sequence and the action sequence may describe changes of the virtual character in at least one dimension (such as an expression and/or an action), thereby enabling the image sequence to represent changes (such as expression changes and action changes) presented by the virtual character when replying to the first speech. In addition, the second speech may indicate speech content of the virtual character when replying to the first speech, so that in the present disclosure, the virtual character can reply to the user with rich expression by playing the second speech and displaying the image sequence, so that the defects of the above automatic answering service may be effectively overcome, thereby facilitating the improvement of user experience. Note that in the context of the present disclosure, a virtual character may comprise a virtual human, an avatar, a digital human, or the like.

In order for persons skilled in the art to better understand the solutions of the present disclosure, the technical solutions in the embodiments of the present disclosure will be described clearly and completely below with reference to the drawings in the embodiments of the present disclosure. Apparently, the described embodiments are merely some rather than all of the embodiments of the present disclosure. All other embodiments derived by a person of ordinary skill in the art based on the embodiments of the present disclosure without paying creative efforts shall fall within the scope of protection of the present disclosure.

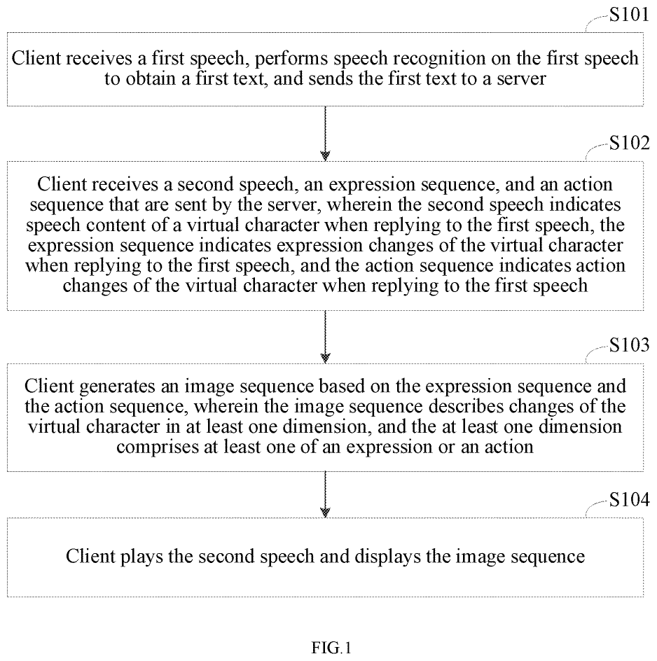

In order to better understand the technical solutions provided in the present disclosure, the data processing method provided in the present disclosure will be described below with reference to some drawings. As shown in FIG. 1, the data processing method applied to a client provided in an embodiment of the present disclosure includes the following S101 to S104.

S101: The client receives a first speech, performs speech recognition on the first speech to obtain a first text, and sends the first text to a server.

The client may provide an interaction service, such as a question answering service, to a user. In addition, the present disclosure does not limit the implementation manner of the client. For example, the client may be implemented by using any terminal device.

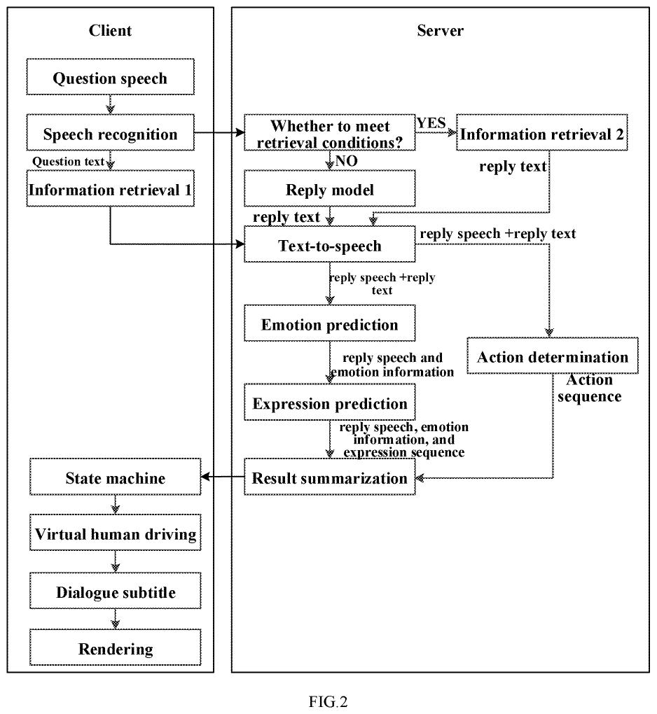

The first speech refers to a speech (such as a question speech shown in FIG. 2) input by a user to the client, so that the first speech may represent a requirement of the user. In addition, the present disclosure does not limit the implementation manner of the first speech. For example, the first speech carries a target question, so that the first speech may indicate an inquiry requirement of the user.

The first text refers to a result (such as a question text shown in FIG. 2) obtained by performing speech recognition on the first speech, so that the first text may represent semantic content (such as the above target question) carried by the first speech. It should be noted that the present disclosure does not limit the implementation manner of the speech recognition. For example, the speech recognition may be performed by using any method that may convert a speech into a text, such as Automatic Speech Recognition (ASR), or any pre-built machine learning model that may implement a speech recognition function.

The server and the client may perform data communication, so that the server may provide some services, such as a data processing service, for the client. It should be noted that the present disclosure does not limit the implementation manner of the server. For example, the server may be implemented by using any server, such as a standalone server, a cluster server, or a cloud server.

Based on the foregoing content of S101, for the client (such as the client shown in FIG. 2), after the client receives the first speech (such as the question speech shown in FIG. 2) input by the user, the client first performs ASR on the first speech to obtain the first text (such as the question text shown in FIG. 2), so that the first text may represent the semantic content carried by the first speech. Then, the client sends the first text to the server, so that the server may process the first text (such as the processing performed by the server shown in FIG. 2).

S102: The client receives a second speech, an expression sequence, and an action sequence that are sent by the server, where the second speech indicates speech content of a virtual character when replying to the first speech, the expression sequence indicates expression changes of the virtual character when replying to the first speech, and the action sequence indicates action changes of the virtual character when replying to the first speech.

The second speech refers to a speech fed back by the server to the client, so that the second speech may indicate speech content of the virtual character when replying to the first speech, thereby enabling the second speech to indicate an answer given by the virtual character to a target question carried by the first speech.

The expression sequence refers to expression information fed back by the server to the client, so that the expression sequence may indicate expression changes (such as lip synchronization changes, also can be referred to as lip sync changes, or viseme changes) of the virtual character when replying to the first speech, thereby enabling the expression sequence to represent expression changes presented by the virtual character when the virtual character plays the second speech, and enabling the expression sequence to represent emotion presented by the virtual character when the virtual character speaks according to the second speech to some extent.

The action sequence refers to action information fed back by the server to the client, so that the action sequence may indicate action changes (such as body posture changes) of the virtual character when replying to the first speech, thereby enabling the action sequence to represent action changes presented by the virtual character during playing of the second speech, and enabling the action sequence to represent a body posture presented by the virtual character when the virtual character speaks according to the second speech to some extent.

S103: The client generates an image sequence based on the expression sequence and the action sequence, where the image sequence describes changes of the virtual character in at least one dimension, where the at least one dimension includes an expression and/or an action.

The image sequence is generated based on the expression sequence and the action sequence, so that expression changes presented in the image sequence are consistent with the expression changes indicated by the expression sequence, and action changes presented in the image sequence are consistent with the action changes indicated by the action sequence, thereby enabling the image sequence to describe the changes of the virtual character in the at least one dimension (such as the expression and/or the action), and enabling the image sequence to represent a driving result for the virtual character. It should be noted that the present disclosure does not limit the implementation manner of the at least one dimension. For example, the at least one dimension may include at least an expression and/or an action.

In addition, the present disclosure does not limit the implementation manner of S103. For example, S103 may be implemented by using any method that may perform image generation (or video generation) based on an expression sequence and an action sequence, such as any virtual character driving method or any pre-built machine learning model that may implement the foregoing functions.

Based on the foregoing content of S103, for the client, after obtaining the expression sequence and the action sequence from the server, the client may perform virtual character driving (such as video generation) based on the expression sequence and the action sequence to obtain the image sequence, so that expression changes presented in the image sequence are consistent with the expression changes indicated by the expression sequence, and action changes presented in the image sequence are consistent with the action changes indicated by the action sequence, thereby enabling the image sequence to better represent multi-dimensional changes presented by the virtual character when replying to the first speech, and enabling the image sequence to better represent multi-dimensional changes presented by the virtual character during playing of the second speech, so that the image sequence may better represent multi-dimensional changes presented by the virtual character when the virtual character speaks according to the second speech, and the virtual character may reply to the user with rich expression through the image sequence, thereby improving user experience.

S104: The client plays the second speech and displays the image sequence.

It should be noted that the present disclosure does not limit the implementation manner of S104. For example, S104 may be specifically: while the second speech is being played on the client, the image sequence can be displayed to the user in a specific manner (such as a rendering manner shown in FIG. 2), so that the user may visually and audibly know a reply given by the client to the first speech input by the user, which is beneficial to improving user experience.

In addition, in some scenarios, in order to better improve user experience, S104 may include: the client plays the second speech, displays the image sequence, and displays a subtitle (such as the subtitle shown in FIG. 2) corresponding to the second speech. The subtitle may indicate semantic content carried by the second speech, so that the subtitle may represent speech content used by the virtual character when the virtual character speaks according to the second speech, thereby enabling the user to better know the reply given by the client to the first speech input by the user through the subtitle, which is beneficial to improving user experience.

It may be learned that in some embodiments, for the above client, when the client plays the second speech, not only the image sequence but also the subtitle corresponding to the second speech needs to be displayed synchronously, so that the user may more clearly know the reply given by the client to the first speech input by the user through the subtitle, thereby improving user experience.

It should be noted that the present disclosure does not limit the acquisition manner of the subtitle corresponding to the second speech. For example, the subtitle may be obtained by the client through performing speech recognition on the second speech. For another example, when the second speech is obtained by the server through performing speech generation (such as text-to-speech shown in FIG. 2) on a second text, the subtitle may be the second text (such as a reply text shown in FIG. 2) sent by the server to the client. Text-to-speech (TTS), also known as speech synthesis, is a technology that may convert text information into speech signals, such as pulse code modulation (PCM) signals. PCM signals may record and transmit audio signals.

Based on the foregoing content of S101 to S104, for the client that may interact with the user, after the client receives the first speech (such as the speech describing the question from the user) input by the user, the client first performs speech recognition on the first speech to obtain the first text (such as the text describing the question from the user), and sends the first text to the server, so that the server may process and feed back the first text. After the client receives the second speech, the expression sequence, and the action sequence that are sent by the server, the client generates the image sequence based on the expression sequence and the action sequence, and the client plays the second speech and displays the image sequence, so that the client may automatically answer the question from the user, thereby reducing the cost of answering. The expression sequence may indicate expression changes of the virtual character when replying to the first speech, and the action sequence may indicate action changes of the virtual character when replying to the first speech, so that the image sequence generated based on the expression sequence and the action sequence may describe changes of the virtual character in at least one dimension (such as an expression and/or an action), thereby enabling the image sequence to represent changes (such as expression changes and action changes) presented by the virtual character when replying to the first speech. In addition, the second speech may indicate speech content of the virtual character when replying to the first speech, so that in the present disclosure, the virtual character can reply to the user with rich expression by playing the second speech and displaying the image sequence, therefore, the defects of the above automatic answering service may be effectively overcome, thereby facilitating the improvement of user experience.

In addition, in order to better improve user experience, the present disclosure further provides a possible implementation of the above client. In this implementation, the client may be a holographic cabin, so that when a virtual character is projected into the holographic cabin by using a three-dimensional (3D) laser, a cabin of the holographic cabin may use technologies such as dynamic light and shadow of multiple reflections and 3D space illusion to ensure that the virtual character presents a 3D effect with a wide-angle view of more than 180 degrees, thereby enabling a user to interact with the virtual character immersively and diminishing a spatial barrier between the user and the virtual character, thereby improving user experience.

It should be noted that the holographic cabin is a naked-eye 3D display device created by using technologies such as a holographic imaging principle. The holographic cabin performs hierarchical perspective processing on a two-dimensional (2D) image based on a spatial illusion principle, and incorporates a sense of depth of space, to generate a naked-eye 3D effect. In addition, the holographic cabin is internally equipped with a high-resolution holographic projection apparatus that uses a laser and an interference principle to encode and restore the light information into a stereoscopic image, thereby providing a realistic three-dimensional image and an immersive experience in a closed space.

In addition, in order to better improve user experience, the present disclosure further provides a possible implementation of the above client. In this implementation, the client may at least meet the following constraints: the client may be a holographic cabin, and a size of a screen of the client is determined based on a height of a real person, so that a virtual character presented by the client may restore the height of the real person in a ratio of 1:1, thereby enabling a user to perform an immersive speech conversation with the virtual character at a close distance and face to face, which is beneficial to improving user experience.

It should be noted that the above “height of the real person” is a result obtained by analyzing heights of a large number of real persons, so that the “height of the real person” may better represent height characteristics of persons in the real world.

Research has found that for a virtual character, if the virtual character lacks emotional expression ability, it is difficult for users to empathize with the virtual character, thus affecting user experience.

Based on the above research, in order to better improve user experience, the present disclosure further provides a possible implementation of the above data processing method applied to a client. In this implementation, the data processing method may include at least the following steps: the client receives emotional information sent by a server, where the emotional information indicates an emotional state of a virtual character when replying to the first speech; and generates an image sequence based on the emotional information, the expression sequence, and the action sequence, so that an emotional state of the virtual character in the image sequence is consistent with the emotional state indicated by the emotional information, thereby enabling the virtual character to reply to the first speech in the emotional state, and enabling the virtual character to have emotional expression ability, effectively overcoming defects caused by the lack of emotional expression ability of the virtual character, which is beneficial to improving user experience.

It should be noted that the present disclosure does not limit an execution moment of the server sending the emotional information, and it only needs to ensure that the execution is completed before the client executes image sequence generation. In addition, in order to better save communication resources, the server may send the emotional information and other information (such as the second speech, the expression sequence, and the action sequence) together to the client.

It may be learned that in some embodiments, for the above client, after the client receives the first speech input by the user, the client first performs speech recognition on the first speech to obtain the first text, and sends the first text to the server, so that the server may process and feed back the first text. After the client receives the second speech, the expression sequence, the action sequence, and the emotional information (such as the emotional information shown in FIG. 2) that are sent by the server, the client generates the image sequence based on the emotional information, the expression sequence, and the action sequence, and the client plays the second speech and displays the image sequence, so that the virtual character may reply to the question from the user on the client according to the emotional state specified by the emotional information, so that the user may easily empathize with the virtual character, which is beneficial to improving user experience.

It should be noted that the present disclosure does not limit the implementation manner of the step “generating the image sequence based on the emotional information, the expression sequence, and the action sequence”. For example, the step may be implemented by using any machine learning model that may implement the foregoing functions or any virtual character driving method that may implement the foregoing functions.

In addition, in order to better improve user experience, the present disclosure further provides a possible implementation of the above generation process of the image sequence. In this implementation, when the expression sequence indicates lip sync changes, the generation process of the image sequence may include: generating a face expression based on the emotional information, where the face expression indicates a face state of the virtual character when replying to the first speech other than lip synchronization, that also can be referred to as lip sync, or viseme; and generating an image sequence based on the face expression, the expression sequence, and the action sequence, so that lip sync changes of the virtual character in the image sequence are consistent with the lip sync changes indicated by the expression sequence, and a face state other than a lip sync of the virtual character in the image sequence is consistent with a state indicated by the face expression, thereby enabling the image sequence to better present a face state presented by the virtual character when replying according to the emotional state indicated by the emotional information, and ensuring that the virtual character presents good emotional expression ability, to better improve user experience.

It may be learned that in some embodiments, for the above client, after the client receives the second speech, the expression sequence, the action sequence, and the emotional information that are fed back by the server for the first speech, the client first generates the face expression based on the emotional information, so that the face expression may express the emotional state (such as joy) indicated by the emotional information, and then, the client generates the image sequence based on the face expression, the expression sequence, and the action sequence, so that the lip sync changes of the virtual character in the image sequence are consistent with the lip sync changes indicated by the expression sequence, and the face state other than the lip sync of the virtual character in the image sequence is consistent with a corresponding state indicated by the face expression, thereby enabling the virtual character in the image sequence to achieve synchronization between the lip sync with the second speech on the premise that the emotional state is expressed, and enabling the virtual character to simulate emotional expression of a normal person, so that the user hardly perceives an abnormality (such as an inaccurate lip sync and incorrect emotion) from the virtual character, which is beneficial to improving user experience.

It should be noted that the present disclosure does not limit the implementation manner of the step “generating the image sequence based on the face expression, the expression sequence, and the action sequence”. For example, the step may be implemented by using any machine learning model that may implement the foregoing functions or any virtual character driving method that may implement the foregoing functions.

It should be further noted that the present disclosure also does not limit the implementation manner of the step “generating the face expression based on the emotional information”. For example, the step may be implemented by using any machine learning model that may implement the foregoing functions or any virtual character driving method that may implement the foregoing functions.

For another example, in some scenarios, when the emotional information includes a predicted probability (such as a predicted score) of at least one candidate emotion, the generation process of the face expression may include: first determining a target emotion with a largest probability from the at least one candidate emotion based on the predicted probability of the at least one candidate emotion; then obtaining an expression template preset for the target emotion, so that the expression template may represent a face muscle contraction state under the target emotion; and then using the expression template as the face expression, so that the face expression may more accurately present the target emotion.

It should be noted that the at least one candidate emotion refers to emotions that are preset and that the virtual character may exhibit. In addition, the present disclosure does not limit the at least one candidate emotion. For example, the at least one candidate emotion may include some or all of a default emotion (also referred to as a calm emotion), a joy emotion (also referred to as a happy emotion), a sad emotion, an angry emotion, and a surprise emotion.

It should be further noted that for any candidate emotion, the predicted probability of the candidate emotion is determined by the server, and the predicted probability may indicate a possibility that the virtual character uses the candidate emotion when replying to the first speech. In addition, the present disclosure does not limit the implementation manner of the predicted probability. For example, the predicted probability may be implemented by using a predicted score.

It should be further noted that for any candidate emotion, the expression template corresponding to the candidate emotion refers to an expression template preset for the target emotion, and the expression template may represent a face expression under the candidate emotion. In addition, the present disclosure does not limit a manner of obtaining the expression template. For example, the expression template may be obtained through manual labeling. For another example, the expression template may refer to a face expression animation of the virtual character recorded for the candidate emotion in advance.

Research has found that for any emotion, the expression template set for the emotion may represent a face muscle contraction state in an extreme case. However, since muscle relaxation states of different individuals at different times change dynamically, expressions presented by the individuals when they express the same emotion at different times may be different.

Based on the above research, in order to better improve an emotional expression effect, the present disclosure further provides a possible implementation of the above generation process of the face expression. In this implementation, when the emotional information includes a predicted probability of at least one candidate emotion, the generation process of the face expression may include: determining a target emotion from the at least one candidate emotion based on the predicted probability of the at least one candidate emotion, where the predicted probability of the target emotion is not less than that of any emotion in the at least one candidate emotion other than the target emotion; and performing weighted fusion on an expression template corresponding to the target emotion and an expression template corresponding to a default emotion based on the predicted probability of the target emotion, to obtain the face expression, where the predicted probability of the target emotion indicates a weight corresponding to the expression template corresponding to the target emotion in the weighted fusion, the expression template corresponding to the target emotion indicates a face state under the target emotion, and the expression template corresponding to the default emotion indicates a face state under the default emotion. In this way, a manner of expressing a current emotion may be optimized by superimposing an emotion template corresponding to the current emotion on a normal expression, which is beneficial to better expressing the current emotion.

It may be learned that in some embodiments, for the client, after the client receives predicted probabilities of respective candidate emotions sent by the server, the client first selects an emotion with a largest probability value from the candidate emotions based on the predicted probabilities, and then the client superimposes, by using the largest probability value as a weight, an expression template corresponding to the emotion with the largest probability value on an expression template corresponding to a default emotion, to obtain the above face expression, so that the face expression may better represent the emotion with the largest probability value, as shown in the following formulas (1) to (2).

$$α = arg {max}_{i ∈ \{ 1 , 2 , … nN \}} {score}_{i} \qquad ( 1 )$$

$$Exp ( output ) = α \times Exp ( {emotion}_{s c ore = α} ) + ( 1 - α ) \times Exp ( natural ) \qquad ( 2 )$$

Where, Exp(output) represents the above face expression; α represents a largest value in the predicted probability of the at least one candidate emotion; scoreᵢ represents a predicted probability of an i-th candidate emotion in the at least one candidate emotion, where i is a positive integer, and i≤the number of emotions in the at least one candidate emotion; emotion_{score=α} represents a target emotion with a largest predicted probability in the at least one candidate emotion; Exp(emotion_{score=α}) represents an expression template corresponding to the target emotion, for example, when the target emotion is the default emotion, Exp(emotion_{score=α}) is Exp(natural), when the target emotion is a happy emotion, Exp(emotion_{score=α}) is Exp(happy), when the target emotion is a sad emotion, Exp(emotion_{score=α}) is Exp(sad), when the target emotion is an angry emotion, Exp(emotion_{score=α}) is Exp(angry), and when the target emotion is a surprise emotion, Exp(emotion_{score=α}) is Exp(surprise); natural represents a default emotion in the at least one candidate emotion; and Exp(natural) represents an expression template corresponding to the default emotion.

Research has found that for a client, when the client interacts with a user, a virtual character displayed by the client may present a plurality of states. For ease of understanding, description will be provided below with reference to an example.

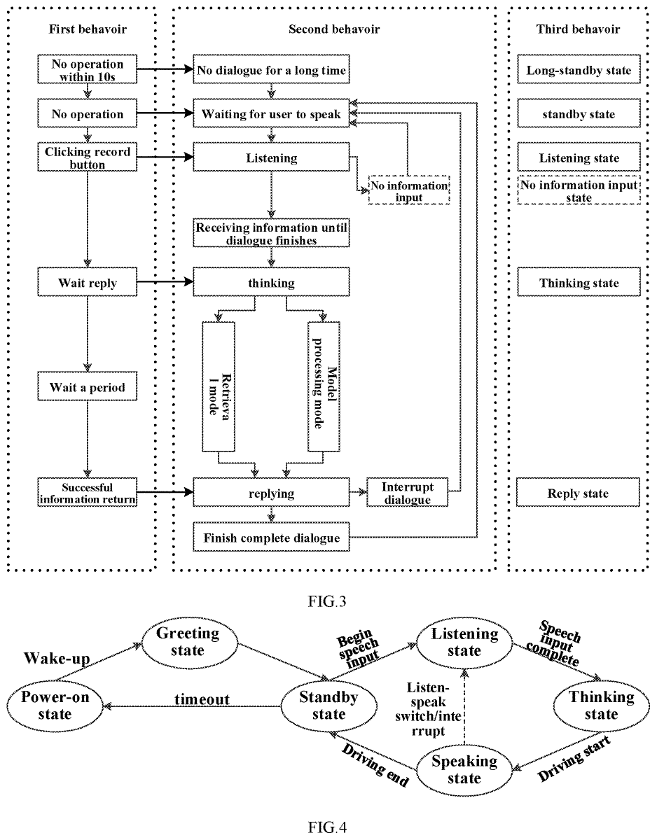

As an example, for a complete human-machine conversation process (a conversation process shown in FIG. 3) implemented based on the above client and server, the process may include: after the user starts up the client (such as a holographic cabin), if the user does not perform any operation within 10 seconds, an interface of the client is in a no-operation state. At this time, because the user does not initiate a conversation for a long time, the virtual character displayed by the client is in a standby state (that is, a state of waiting for the user to speak), thereby enabling the virtual character to present states such as maintaining a smile and a natural standing posture. Then, the user clicks on a recording button, and inputs, through a speech microphone, question speech “What are the features of this product?” At this time, the virtual character displayed by the client enters a listening state, thereby enabling the virtual character to present states such as slightly leaning forward, slightly nodding, and concentrating eyes. Next, after the user finishes speaking, the user enters a state of waiting for a reply from the virtual character. At this time, because the client receives a signal indicating the end of speaking, the virtual character displayed by the client enters a thinking state, so that the virtual character presents states, such as occasionally supporting the chin and frowning, that may represent thinking. In addition, because the question includes a keyword “product feature”, a retrieval mode (a retrieval mode shown in FIG. 3), namely, frequently asked questions (FAQ), is triggered, and the server (or the client) searches a database corresponding to the retrieval mode for relevant information, to enter a reply state, to provide a detailed answer to the question for the user. In addition, in a process in which the user waits for an answer, after waiting for a period of time, the user finally got a successful information return. At this time, the user may watch and hear the reply content provided by the client. In addition, in the reply state, the virtual character displayed by the client may perform a series of actions, such as talking and using gestures to assist in describing various features of the product, and meanwhile, an introduction video or picture and text information about relevant product features may also be inserted on the interface of the client, to vividly complete a complete conversation with the user.

It may be learned that for a complete human-machine conversation process (a conversation process shown in FIG. 3) implemented based on the above client and server, the process may include a first action, a second action, and a third action. The first action occurs at an application physical layer of the client, so that the first action may at least collect information such as an operation triggered by a user and a speech instruction input by the user, etc. The second action occurs at the server, so that the second action may at least understand a conversation intention and generate reply results and feedback information in different scenarios based on questions. The third action occurs at a display layer of the client, so that the third action may at least drive a virtual character to perform script deduction or question reply, and the third action may occur actively or passively.

Based on the above example, in order to better improve a service effect, the present disclosure further provides a possible implementation of the above client. In this implementation, the client includes a state machine (a state machine shown in FIG. 4), and the state machine indicates a switching relationship of a virtual character displayed by the client between different states. In this way, the state machine may be used to ensure that the client supports state transition of the virtual character in different scenarios, to improve flexibility.

It should be noted that the present disclosure does not limit the implementation manner of the above state machine. For example, as shown in FIG. 4, the state machine may indicate a switching relationship between a power-on state, a greeting state, a standby state, a listening state, a thinking state, and a speaking state. The power-on state is an initial state of the virtual character displayed by the client after the client starts up, and the greeting state may be entered after the virtual character is awakened, and the standby state is entered immediately after the greeting is completed. The standby state is a state in which the virtual character waits for a user instruction, and the listening state is entered after speech input of the user is received. The standby state may also be returned after the speaking state ends. When the standby state is maintained for more than a certain time, the power-on state is restored, and at this time, the virtual character needs to be awakened again. The listening state is a state entered after the speech input of the user is received, so that the thinking state is entered after the speech input ends. The thinking state is a state that the client and the server are in when processing the user input, and the speaking state is entered after the processing is completed. The thinking state may be interrupted by listening and speaking. The speaking state is a state of the virtual character when replying to the user. After the speaking state ends, if no speech input of the user is detected within a preset time, the standby state is entered. However, if the speech input of the user is detected within the preset time, the listening state is entered.

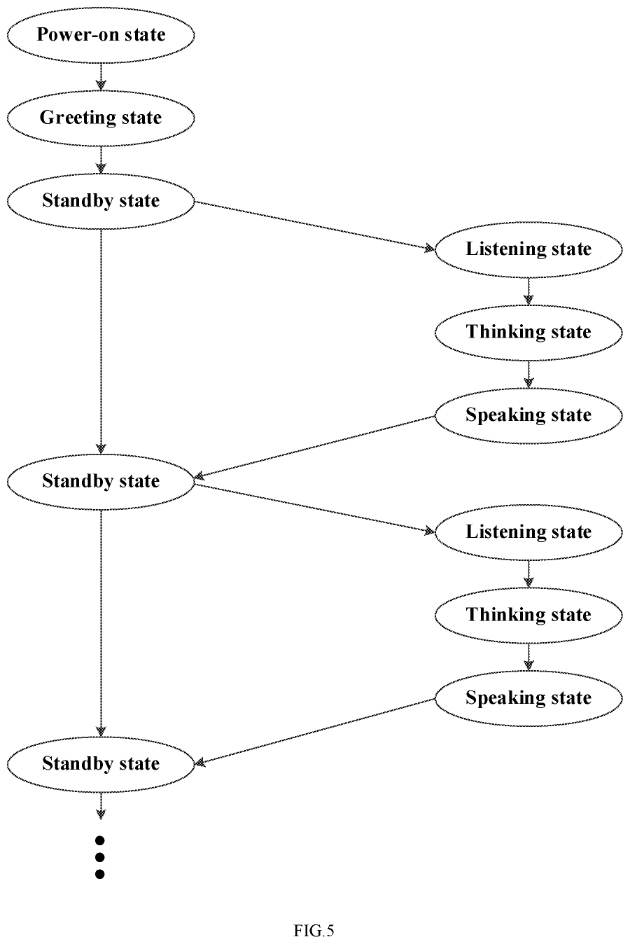

It should be further noted that for the above state machine, after one round of interaction from the listening state to the thinking state and then to the speaking state is completed, the standby state may be returned to for looping, such as the looping shown in FIG. 5. Meanwhile, after being awakened, the virtual character first greets and then enters the standby state. When the client and the server process the user input, the thinking state is entered from the listening state, so that the speaking state is entered from the thinking state when the client replies to the user input through the virtual character.

It may be learned based on the foregoing related content of the state machine that, in order to better improve user experience, the present disclosure further provides a possible implementation of the above data processing method applied to a client. In this implementation, when the client includes a state machine, and the state machine indicates a switching relationship of a virtual character displayed by the client between different states, the data processing method may include at least the following step: the client updates state information of the virtual character based on the state machine, where the updated state information indicates that the virtual character switches to a speaking state. In some embodiments, such step can be executed after the client receives some information (such as a second speech, an expression sequence, an action sequence, and emotional information) sent by a server. In this way, the speaking state may be automatically entered from a listening state based on the information fed back by the server, which is beneficial to improving flexibility of state transition of the virtual character.

It may be learned that in some embodiments, for a client (the client shown in FIG. 2), after the client receives some information (such as a second speech, an expression sequence, an action sequence, and emotional information) that is fed back by a server for a first speech input by a user, the client first switches state information of a virtual character from a listening state to a speaking state, and then provides the information to the user visually and audibly by driving the virtual character based on the information.

Research has found that in order to better improve the realism of a virtual character, the control of some body features (such as eye control) may be performed on the virtual character. For example, in a standby state, a blinking frequency of the virtual character may be controlled to be consistent with that in a real scenario. In a listening state, a thinking state, or a speaking state, the virtual character may be controlled to blink once every 2.2 to 3 seconds on average. In addition, in order to better guide the user to implement, in the listening state, the thinking state, or the speaking state, a head, eyes, and even a body of the virtual character may also be controlled to face a camera (such as a virtual camera used during rendering).

Based on the above research, in order to better improve user experience, the present disclosure further provides a possible implementation of the above data processing method applied to a client. In this implementation, when the client includes a state machine, and the state machine indicates a switching relationship of a virtual character displayed by the client between different states, the data processing method may include at least the following steps: the client first updates state information of the virtual character based on the state machine, so that the updated state information indicates that the virtual character switches to a speaking state; and then generates an image sequence based on the information and at least one body feature corresponding to the updated state information, where the at least one body feature includes some or all of a blinking frequency, a head orientation, an eye orientation, and a body orientation, so that the virtual character in the image sequence generated based on these body features may meet these body features, thereby making the virtual character in the image sequence more real, to better improve user experience. In some embodiments, such steps can be executed after the client receives some information (such as an expression sequence, an action sequence, and emotional information) sent by a server.

It may be learned that for the client (the client shown in FIG. 2), after the client receives the second speech, the expression sequence, the action sequence, and the emotional information that are fed back by the server for the first speech input by the user, the client first switches the state information of the virtual character from the listening state to the speaking state, and then, the client searches a pre-established mapping relationship for some body features (such as a blinking frequency, a head orientation, an eye orientation, and a body orientation) matching the speaking state, so that these body features may represent some body characteristics of the virtual character displayed by the client in the speaking state. Next, the client generates an image sequence based on these body features, the expression sequence, the action sequence, and the emotional information, so that the virtual character in the image sequence may at least present these body features. Finally, the client plays the second speech and the image sequence concurrently, so that the user may obtain responses visually and audibly. The mapping relationship records some body features corresponding to various states, and the mapping relationship may be pre-established based on a virtual character requirement in an actual application scenario.

It should be noted that the present disclosure does not limit the implementation manner of the step “generating the image sequence based on these body features, the expression sequence, the action sequence, and the emotional information”. For example, the step may be implemented by using any pre-built machine learning model that may implement the foregoing functions.

Research has found that in some scenarios, the client may not only passively reply to a question input by the user, but also actively broadcast some content, such as actively initiating a chat, introducing a product, and performing some timing tasks by the virtual character displayed by the client.

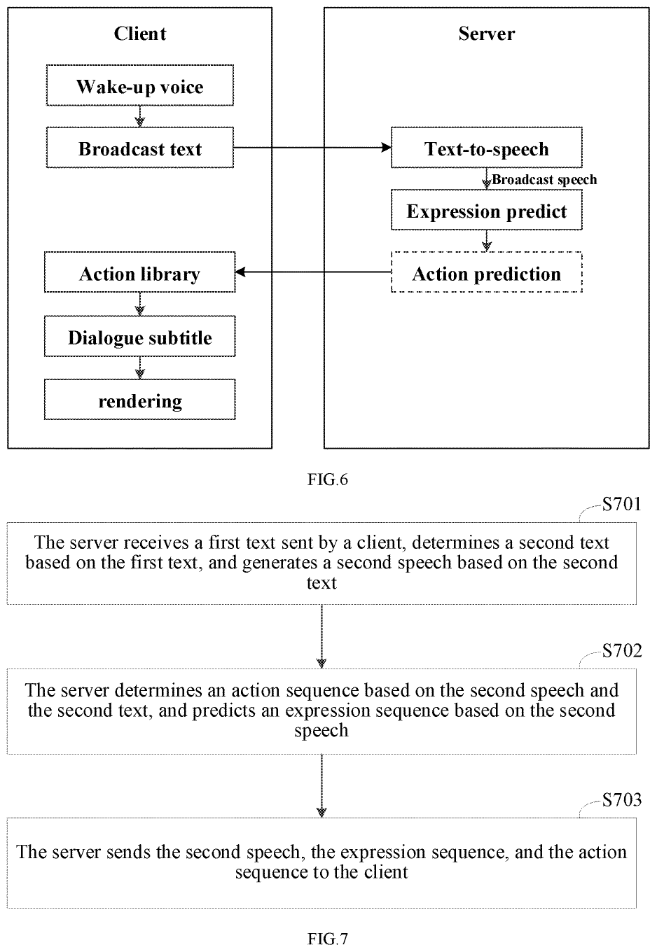

Based on the above research, in order to better meet the requirements as discussed above, the present disclosure further provides a possible implementation of the above data processing method applied to a client. In this implementation, the data processing method may include at least the following steps: the client receives a first speech; and in response to detecting an absence of a preset feature (also referred to as a first feature) in the first speech, for example, in response to not detecting that the first speech has the first feature, the client performs speech recognition on the first speech to obtain a first text (a question text shown in FIG. 2) and sends the first text to a server, where the preset feature indicates a feature of a speech (a wake-up speech shown in FIG. 6) replied by the virtual character displayed by the client in a broadcast manner. Additionally or alternatively, the data processing method may include at least the following steps: the client receives a first speech; and in response to detecting that the first speech has the preset feature, the client sends a text (a broadcast text shown in FIG. 6) corresponding to the preset feature to the server. In this way, the virtual character displayed by the client has not only a question answering function, but also an automatic broadcast function, which is beneficial to better meeting user requirements in different scenarios, thereby facilitating better improvement of user experience.

It should be noted that the above preset feature refers to a characteristic of user speech (the wake-up speech shown in FIG. 6) that needs to be replied by the client in a broadcast manner, such as carrying a wake-up word, carrying preset information (such as a word, an event, and a tone, etc.), etc. In addition, the present disclosure does not limit the implementation manner of the preset feature. For example, the preset feature may be determined based on an automatic broadcast requirement in a current application scenario.

It should be further noted that for the text corresponding to the above preset feature, the text may be a preset text that is bound to the preset feature and needs to be displayed to the user in an automatic broadcast manner, such as the broadcast text shown in FIG. 6. In addition, the present disclosure does not limit the implementation manner of the text. For example, the text may be a copy or a script edited according to speech synthesis markup language (SSML) rules, so that the text not only records speech content of the virtual character, but also records some speech characteristics of the virtual character, such as pronunciation characteristics, actions, and events. The SSML is a markup language based on extensible markup language (XML), and the SSML may mark and annotate text in a speech synthesis system, to better control a manner and an effect of speech output. In addition, the present disclosure does not limit a process of the server for the text. For example, as shown in FIG. 6, the process may include: after receiving the text, the server first uses TTS to convert the text into broadcast speech; then performs expression prediction (such as lip sync prediction) on the broadcast speech to obtain an expression sequence corresponding to the text; and then provides the broadcast speech and the expression sequence to the client. In addition, the client may determine an action sequence corresponding to the text by using an action library. In addition, the action sequence corresponding to the text may be obtained by fusing a result of action prediction for the broadcast speech by the server through using an action prediction model and a result of query for the text by the client from the action library. The present disclosure does not limit the manner of obtaining the action sequence, and the manner of obtaining the action sequence may be determined based on an actual application scenario.

It may be learned based on the foregoing that in some embodiments, for the client, after the client receives the first speech input by the user, if the client detects that a user requirement indicated by the first speech is a question answering requirement, the client may first perform speech recognition on the first speech to obtain the first text, so that the first text may represent a question described by the first speech. Then, the client sends the first text to the server, so that the server may generate, based on the first text, reply speech (reply speech shown in FIG. 2) to the question and related information (emotional information, an expression sequence, an action sequence, and the like shown in FIG. 2) for feedback to the client for use. However, if the client detects that the user requirement indicated by the first speech is a wake-up requirement, the client may obtain a preset text for wake-up and send the preset text to the server, so that the server may generate, based on the “preset text for wake-up”, corresponding speech (broadcast speech shown in FIG. 6) and related information (such as an expression sequence, an action sequence, etc.) for feedback to the client for use. In this way, the client supports not only the question answering function, but also the automatic broadcast function, thereby enabling the client to meet usage requirements in more scenarios.

Research has found that in some scenarios, such as a scenario with a high requirement for data security, a database capable of performing answer retrieval may be deployed on a client, to protect data stored in the database.

Based on the above research, in order to better meet the requirements shown in the above paragraph, the present disclosure further provides a possible implementation of the above data processing method applied to a client. In this implementation, when the client includes a first database (a local database used for information retrieval 1 shown in FIG. 2), the data processing method may include at least the following steps: the client receives a first speech, and performs speech recognition on the first speech to obtain a first text; the client sends the first text to a server in response to the first text not satisfying a retrieval condition of the first database, so that the server may generate feedback information (such as the above second speech, expression sequence, action sequence, and emotional information, or other information) based on the first text. Additionally or alternatively, the client may send a retrieval result of the first text in the first database to the server in response to the first text satisfying the retrieval condition of the first database, so that the server generates the feedback information based on the retrieval result (output data of information retrieval 1 shown in FIG. 2). In this way, the security of some data may be protected by deploying a database locally on the client, thereby enabling the client to better meet requirements in a scenario with a high requirement for data security.

It should be noted that the above first database refers to a database that is deployed on the client and stores some question and answer pairs, so that the first database may be used to perform FAQ mode retrieval processing locally on the client, so that answers to some questions (the output data of information retrieval 1 shown in FIG. 2) may be subsequently retrieved from the first database. In addition, the present disclosure does not limit the first database. The first database may be manually created on the client by a relevant person, or may be automatically constructed by the client based on a large amount of materials provided by a user. In addition, the retrieval condition of the first database refers to a condition that needs to be met by a question for which an answer may be retrieved from the first database. In addition, the present disclosure does not limit the retrieval condition. For example, the retrieval condition may be: at least one keyword in a question input by the user belongs to a keyword existing in the first database.

It may be learned based on the foregoing that in some embodiments, for the client, when the client includes a local database (such as the first database), after the client receives the first speech input by the user, the client first performs speech recognition on the first speech to obtain the first text. Then, the client determines whether each word in the first text belongs to a keyword existing in the local database. If it is determined that no word in the first text belongs to the keyword existing in the local database, it may be determined that no answer to the first text exists in the local database, and therefore the client sends the first text to the server, so that the server may generate a reply speech and related information (such as emotional information, an expression sequence, and an action sequence) based on the first text, for feedback to the client for use. However, if it is determined that at least one word in the first text belongs to the keyword existing in the local database, it may be determined that there exists an answer to the first text in the local database, and therefore the client may perform answer retrieval for the first text in the local database to obtain the retrieval result, and the client sends the retrieval result to the server, so that the server may generate the reply speech and related information based on the retrieval result, for feedback to the client for use. In this way, the security of some data may be protected by using the local database, thereby enabling the client to better meet requirements in a scenario with a high requirement for data security.

It should be noted that the present disclosure does not limit the implementation manner of the step “the server may generate the reply speech and related information based on the retrieval result”. For example, the step may include other processes in any implementation of the above step “the server may generate the reply speech and related information based on the first text” other than an answer text generation process, for example, an implementation process of processing the output data of information retrieval 1 by the server shown in FIG. 6.

It may be learned based on the foregoing content of the client that the client provided in the present disclosure has at least the following functions: (1) The client may process user input. Specifically, the client may collect user speech through a microphone, invoke an ASR service to convert the user speech into text information. (2) The client may process information provided by the server. Specifically, the client may analyze data such as audio (PCM), expression (Blend Shape, BS), bone action (Bone), and event signals (such as event signals recorded in the broadcast text) that are fed back by the server. (3) The client may perform rendering and interaction. Specifically, the client may finally perform rendering and display through a render module (Render) in conjunction with information such as a state machine, an expression template, and a subtitle, to implement real-time visual interaction with the user.

It should be noted that the BS is a technology for creating different shapes by deforming vertices of a basic model (such as a face model), and the BS may mix these shapes together with different weights to achieve smooth transition and deformation effects. The Bone may indicate rotation and offset of a body bone. The Render refers to a virtual character renderer, and the Render may receive some drive signals and instructions to control the virtual character to perform actions and expressions.

It should be further noted that for the above client, the client may play a pre-recorded animation by default in the standby state, the listening state, or the thinking state. In addition, the animation in the standby state may be obtained by recording long lens data of a real person and using a long template animation. In addition, in the present disclosure, a nod animation in an interaction scenario may be pre-produced, so that in the thinking state, the client may select whether to add the nod animation, whether to increase a nod speed, whether to increase a nod amplitude, and the like based on an audio rhythm of user speech, for example, based on an audio rhythm indicated by signals such as a start point (Onset) signal and a peak (Peak) signal, etc. The Onset refers to a start point of a signal, that is, a time moment when the signal starts to change. The Peak refers to a maximum value or a highest point reached by the signal at a specific time moment.

Based on the foregoing content of the client, in order to better provide a corresponding service for the client, the present disclosure further provides a data processing method applied to a server. As shown in FIG. 7, the method includes the following S701 to S703.

S701: The server receives a first text sent by a client, determines a second text based on the first text, and generates a second speech based on the second text.

For the related content of the first text, reference can be made to the foregoing description. For the sake of brevity, details are not described herein again.

The second text refers to an answer determined by the server for a question indicated by the first text, so that the second text may represent speech content used when the first text (or the first speech) is replied to. In addition, the present disclosure does not limit a manner of determining the second text. For example, the second text may be determined by using any method that may generate an answer for a question, for example, any machine learning model that may implement the foregoing functions.

The second speech refers to speech data generated based on the second text, so that the second speech may represent, in an audio manner, semantic content carried by the second text, thereby enabling the second speech to represent speech audio used when the first text (or the first speech) is replied to. It should be noted that the present disclosure does not limit a manner of generating the second speech. For example, the second speech may be generated by using any method that may generate speech based on text, such as TTS, or any machine learning model that may implement the foregoing functions.

It may be learned based on the foregoing content of S701 that for the server, after the server receives the first text that may represent a question and that is sent by the user, the server first performs answer determination processing on the first text to obtain the second text, so that the second text may represent, in a text manner, reply content for the question indicated by the first text. Then, TTS is used to perform speech generation on the second text to obtain the second speech, so that the second speech may represent the reply content in an audio manner.

S702: The server determines an action sequence based on the second speech and the second text, and predicts an expression sequence based on the second speech.

The action sequence refers to some actions determined based on the second speech and the second text, so that the action sequence may indicate action changes presented by the virtual character during playing of the second speech, thereby enabling the action sequence to represent action changes presented when the first text (or the first speech) is replied to.

In addition, the present disclosure does not limit the process of determining the action sequence. For example, the action sequence may be determined by using any method that may generate an action based on speech and text, such as any machine learning model or artificial intelligence (AI) motion (Motion) service that may implement the foregoing functions. The AI Motion refers to a method that may drive body movements of the virtual character through a speech signal and an AI prediction means. For another example, the action sequence may be determined by querying the action library for a matching action.

The expression sequence refers to some expression information (such as lip sync information, etc.) predicted based on the second speech, so that the expression sequence may indicate expression changes presented by the virtual character during playing of the second speech, thereby enabling the expression sequence to represent expression changes presented when the first text (or the first speech) is replied to.

In addition, the present disclosure does not limit the process of predicting the expression sequence. For example, the expression sequence may be predicted by using any method that may predict an expression based on speech, such as any machine learning model, any lip sync prediction model, or any AI face (Face) service that may implement the foregoing functions. The AI Face refers to a method that may drive a lip shape and an expression of the virtual character through a speech signal and an AI prediction means.

In addition, the present disclosure does not limit the characteristic of a lip sync indicated by the expression sequence. For example, the lip sync may be implemented by using an Arkit standard, so that the expression sequence may be predicted by a lip sync driving model that is pre-trained based on training data in the Arkit standard.

For another example, in order to better present a speaking state with richer expressions and more standard pronunciation, the lip sync may be implemented by using an Iclone standard, so that the expression sequence may be predicted by a lip sync driving model that is pre-trained based on training data in the Iclone standard, thereby enabling the expression sequence to present stronger expressiveness of facial muscles and distinguishability between different pronunciation lip syncs.

S703: The server sends the second speech, the expression sequence, and the action sequence to the client.

It should be noted that the present disclosure does not limit the implementation of S703. For example, in order to better save communication resources, S703 may be as follows: the server first summarizes the second speech, the expression sequence, and the action sequence to obtain a summary result; and then the server sends the summary result to the client.

It may be learned based on the foregoing content of S701 to S703 that for the server, after the server receives the first text (such as the question text shown in FIG. 2) sent by the client, the server first determines the second text (such as the reply text shown in FIG. 2) based on the first text, so that the second text may represent the reply content for the question indicated by the first text. Then, the second speech (such as the reply speech shown in FIG. 2) is generated based on the second text, so that the second speech may represent the speech content used when the first text is replied to. Next, the server determines the action sequence (such as the action sequence shown in FIG. 2) based on the second speech and the second text, so that the action sequence may represent the action changes presented when the first text is replied to, and the server predicts the expression sequence (such as the expression sequence shown in FIG. 2) based on the second speech, so that the expression sequence may represent the expression changes presented when the first text is replied to. Finally, the server sends the second speech, the expression sequence, and the action sequence to the client for use, so that the client may reply to the first text with voice and emotion based on such information, to improve user experience. The action sequence and the expression sequence are both determined based on the second speech, so that the action changes indicated by the action sequence and the action changes indicated by the expression sequence are both highly correlated with the speech content indicated by the second speech, thereby enabling the virtual character presented when the client replies based on such information to present better personified expression, which is further beneficial to better improving user experience.

In addition, in order to better improve an action determination effect, the present disclosure further provides a possible implementation of the step “determining an action sequence based on the second speech and the second text”. In this implementation, the step may include the following steps: for any word in the second text, searching a pre-built action library for an action matching the word to obtain a matching result for the word, so that the matching result may represent whether there is an action in the action library matching the word, and determining start and end times (such as a start time and an end time) of an audio segment corresponding to the word from the second speech in response to the matching result indicating that there exists an action in the action library that matches the word, so that the start time and the end time may represent a playing time of the audio segment corresponding to the word when the first text is replied to, thereby enabling the start time and the end time to represent a usage time of the word when the first text is replied to, and enabling the start time and the end time to represent to some extent a display time of the action matching the word when the first text is replied to; and fusing the action matching the word and an action prediction result generated based on the second speech, to obtain the action sequence, so that the action sequence may better represent the action changes when the first text is replied to, which is beneficial to improving accuracy of action determination.

It should be noted that the above action library refers to a pre-built database that records actions of a large number of words (such as some words with a relatively high word frequency). In addition, the present disclosure does not limit a method for building the action library. For example, the method may be specifically as follows: first, analyzing a large number of words to obtain some words with a high word frequency (also referred to as hot words); then, separately creating animation clips for the words with high word frequency, so that an animation clip may represent actions that need to be used when the corresponding word appears; and then, building an action library based on correspondences between the words with high word frequency and the animation clips, so that the action library may record actions associated with the words with high word frequency. In addition, the present disclosure does not limit the implementation of the animation clips. For example, an average duration of the animation clip is 2 to 4 seconds. For another example, a start posture and an end posture in the animation clip are consistent.

It should be further noted that the above action prediction result refers to an action sequence obtained by performing action prediction on the second speech, so that the action prediction result may represent an action sequence that meets some characteristics of the second speech, such as audio characteristics such as rhythm. It may be learned that in some embodiments, the action prediction result may indicate a characteristic of the second speech carrying information other than semantic information.

It should be further noted that the present disclosure does not limit the implementation of the step “fusing the action matching the word and the action prediction result generated based on the second speech, to obtain the action sequence”. For example, the step may be implemented by using any method (such as concatenating) that may synthesize two action sequences into one action sequence. For another example, the step may be as follows: inserting the action matching the word into the action prediction result according to the start and end times, to obtain the action sequence.

Research has found that for a certain word (such as the word “hello”), the word should appear at the start of a sentence, rather than at the end of the sentence, so that an action matching the word should not appear at the end of the sentence. It should be noted that the end of the sentence refers to an end of a complete sentence.

Based on the above research, in order to better meet the above requirements, the present disclosure further provides a possible implementation of the step “fusing the action matching the word and the action prediction result generated based on the second speech, to obtain the action sequence”. In this implementation, the step may include: determining an insertion time of the action matching the word based on the start and end times, so that the insertion time may represent a display timing of the action matching the word when replying; and in response to a position indicated by the insertion time in the second text not being an end of a sentence, concatenating the action matching the word and the action prediction result based on the insertion time to obtain a concatenation result, and performing smoothing on the concatenation result to obtain the action sequence. In this way, inserting an action at some inappropriate positions may be effectively avoided, which is beneficial to better improving the accuracy of action determination.

It should be noted that for any word, the insertion time of the action matching the word is determined based on the start and end times of the audio segment corresponding to the word in the second speech, so that the insertion time may represent the display timing of the action matching the word when replying. In addition, the present disclosure does not limit the implementation manner of the insertion time. For example, when the start and end times include a start time and an end time, the insertion time refers to a moment randomly selected in a time period from the start time to the end time. For another example, because an action matching a certain word is suitable to be displayed after the displaying of the word is done, an action matching another certain word is suitable to be displayed while the word starts to be displayed, and an action matching yet another certain word is suitable to be displayed after waiting for a short time after the word starts to be displayed, in order to better improve an action display effect, the insertion time may be determined based on the start and end times and an action display requirement of the word, so that the insertion time meets the action display requirement. The action display requirement may represent a relative relationship between the display timing of the action matching the word and a display time period of the word.

It may be learned based on the foregoing that for the server, after the server obtains the second text and the second speech, the server uses an action library to perform action matching on some words in the second text, to obtain actions in terms of semantics, and the server uses an action prediction model to perform action prediction on the second speech, to obtain actions in terms of rhythm and the like. Then, the server fuses the two types of actions into one action sequence in a specific manner, and provides the action sequence to the client for use. The action sequence is obtained through action selection and smoothing, so that the action sequence may relatively accurately represent the action changes when replying, thereby enabling the client to directly use the action sequence without performing selection and smoothing on the action sequence, which is beneficial to improving the display effect of the client.

In addition, in some scenarios, the foregoing action selection and smoothing may also be performed by the client. It may be learned that in some embodiments, the present disclosure further provides a solution of action matching, inserting, and concatenating based on words with high word frequency, and the solution includes at least the following steps: first, creating an animation clip for each word with high word frequency, where an average duration of the animation clip is 2 to 4 seconds, and a start posture and an end posture in the animation clip are consistent, so that the server may subsequently search these animation clips for an animation clip associated with a word with high word frequency that appears in the second text, find start and end times corresponding to the word with high word frequency that appears in the second text on an audio track, and record the start and end times through an SSML action tag; and then, after the server sends such information to the client, when the client plays the second speech to a specified position of the animation clip, determining whether an insertion timing of the animation clip is at an end of a sentence, and if yes, discarding the animation clip; if no, inserting the animation clip through a smoothing algorithm. The start posture in each animation clip is fixed, which may ensure that basic postures of actions before and after an action key frame that may indicate the word are substantially consistent, thereby facilitating improvement of consistency.

It may be learned based on the content of the above paragraph that in some embodiments, for a client with relatively rich computing resources, a working principle of the client may include at least the following steps: after the client receives information such as the second text, the second speech, the expression sequence, and the action sequence that are sent by the server, if the action sequence includes an action prediction result predicted based on the second speech and an action matched from the action library based on the second text, and the second text includes an insertion time of the matched action recorded through SSML, the client generates the above image sequence based on such information sent by the server, so that the image sequence includes an image corresponding to each frame of action in the action prediction result and an image corresponding to the matched action, so that during display of the image sequence, in response to playing the image corresponding to the matched action, the client determines whether a position indicated by the insertion time of the matched action in the second text is an end of a sentence, and if yes, skips the image corresponding to the matched action; if no, performs smoothing on the image corresponding to the matched action and an adjacent image (such as a previous frame image and/or a next frame image) of the image corresponding to the matched action in the image sequence, to obtain and sequentially play a smoothed result of the image corresponding to the matched action and a smoothed result of the next frame image. In this way, the client may fuse actions from different sources, which is beneficial to reducing the processing pressure of the server.

It should be noted that the above previous frame image refers to an image that exists in the image sequence, is adjacent to the above “image corresponding to the matched action” in position, and has an arrangement position prior to that of the “image corresponding to the matched action”. The above next frame image refers to an image that exists in the image sequence, is adjacent to the above “image corresponding to the matched action” in position, and has an arrangement position subsequent to that of the “image corresponding to the matched action”.

In addition, in order to better improve an expression prediction result, the present disclosure further provides a possible implementation of the above data processing method applied to a server. In this implementation, the data processing method may include at least the following steps: the server predicts emotional information based on the second speech and the second text, so that the emotional information may indicate an emotional state presented during playing of the second speech; and predicts the expression sequence based on the emotional information and the second speech, so that the expression sequence may present expression changes in the emotional state indicated by the emotional information, thereby enabling the expression sequence to more accurately represent expression changes (such as lip sync changes) presented during playing of the second speech, which is beneficial to improving accuracy of expression prediction.

It should be noted that the present disclosure does not limit the implementation manner of the step “predicting emotional information based on the second speech and the second text”. For example, the step may be implemented by using any method that may recognize emotion based on speech and text, such as any machine learning model that may implement the foregoing functions.

It should be further noted that the present disclosure does not limit the implementation manner of the step “predicting the expression sequence based on the emotional information and the second speech”. For example, the step may be implemented by using any method that may generate an expression (such as a lip sync) based on emotion and speech, such as any machine learning model that may implement the foregoing functions.

In addition, in order to better improve an action prediction result, the present disclosure further provides a possible implementation of the above data processing method applied to a server. In this implementation, the data processing method may include at least the following steps: the server predicts emotional information based on the second speech and the second text, so that the emotional information may indicate an emotional state presented during playing of the second speech; and determines the action sequence based on the emotional information, the second speech, and the second text, so that the action sequence may present action changes in the emotional state indicated by the emotional information, thereby enabling the action sequence to accurately represent the action changes presented during playing of the second speech, which is beneficial to improving accuracy of action prediction.

It should be noted that the present disclosure does not limit the implementation manner of the step “determining the action sequence based on the emotional information, the second speech, and the second text”. For example, the step may be implemented by using any method that may generate an action based on emotion, speech, and text, such as any machine learning model that may implement the foregoing functions.

For another example, the step “determining the action sequence based on the emotional information, the second speech, and the second text” may be specifically as follows: first, generating an action prediction result based on the emotional information and the second speech; and then, determining the action sequence based on the action prediction result and an action matched for the second text from an action library. The present disclosure does not limit the implementation manner of the step “generating an action prediction result based on the emotional information and the second speech”. For example, the step may be implemented by using any method that may predict an action based on emotion and speech, such as any machine learning model that may implement the foregoing functions.

In addition, in order to better improve the display effect of the client, the present disclosure further provides a possible implementation of the above data processing method applied to a server. In this implementation, the data processing method may include at least the following steps: the server predicts emotional information based on the second speech and the second text; and the server sends the emotional information, the second speech, the above expression sequence, and the above action sequence to the client, so that the client may reply with emotion based on such information, which is beneficial to improving the emotional expression ability of the client.

It may be learned that in some embodiments, for the server, after the server receives the first text (such as the question text shown in FIG. 2) sent by the client, the server first determines the second text (such as the reply text shown in FIG. 2) based on the first text. Then, the server generates the second speech (such as the reply speech shown in FIG. 2) based on the second text. Next, the server predicts the emotional information (the emotional information shown in FIG. 2) based on the second speech and the second text, the server predicts the expression sequence (the emotional sequence shown in FIG. 2) based on the emotional information and the second speech, and the server determines the action sequence (the action sequence shown in FIG. 2) based on the second speech and the second text. Finally, the server summarizes and then sends the second speech, the expression sequence, the action sequence, and the emotional information to the client for use, so that the client may reply to the first text with voice and emotion based on such information, to improve user experience.

In addition, in some scenarios, in order to better improve an answer determination effect, the present disclosure further provides a possible implementation of the above data processing method applied to a server. In this implementation, when the server includes a second database (a database used for information retrieval 2 shown in FIG. 2), the data processing method may include at least the following steps: the server receives a first text sent by a client, and in response to the first text satisfying a retrieval condition of the second database, the server performs retrieval on the first text in the second database to obtain a second text; and additionally or alternatively, in response to the first text not satisfying the retrieval condition of the second database, the server inputs the first text into a pre-built reply model (the reply model shown in FIG. 2) to obtain the second text output by the reply model. In this way, Answer determination may be implemented in a plurality of manners, which is beneficial to better improving accuracy of the answer.

It should be noted that the above second database refers to a database that is deployed on the server and stores some question and answer pairs, so that the second database may be used to perform FAQ mode retrieval processing on the server, so that answers to some questions (output data of information retrieval 2 shown in FIG. 2) may be subsequently retrieved from the second database. In addition, the present disclosure does not limit the second database. The second database may be manually created by a relevant person on the server, or may be automatically constructed by the server based on a large amount of materials provided by a user. In addition, the retrieval condition of the second database refers to a condition that needs to be met by a question for which an answer may be retrieved from the second database. In addition, the present disclosure does not limit the retrieval condition. For example, the retrieval condition may be: at least one keyword in a question input by the user belongs to a keyword existing in the second database.

It may be learned based on the foregoing two paragraphs that in some embodiments, for the server, when the server includes the second database, after the server receives the first text sent by the client, the server first determines whether each word in the first text belongs to a keyword existing in the second database. If it is determined that no word in the first text belongs to a keyword existing in the second database, it may be determined that no answer to the first text exists in the second database, and therefore the server inputs the first text into the pre-built reply model, so that the reply model may perform answer prediction processing on the first text, to obtain and output the second text. However, if it is determined that at least one word in the first text belongs to the keyword existing in the second database, it may be determined that the answer to the first text exists in the second database, and therefore the server may perform answer retrieval for the first text in the second database to obtain the second text. In this way, accuracy of the answer may be better improved by combining a retrieval mode and a model processing mode (the model processing mode shown in FIG. 3).

In addition, in order to better improve accuracy of the answer, the present disclosure further provides a possible implementation of the above data processing method applied to a server. In this implementation, when the first text indicates semantic content carried by a first speech, the data processing method may include at least the following steps: the server receives an emotion recognition result sent by the client, where the emotion recognition result indicates emotional information carried by the first speech; and the server inputs the first text and the emotion recognition result into a pre-built reply model to obtain the second text output by the reply model, so that the answer given by the second text may better match an emotional state indicated by the emotional information, thereby making the reply implemented based on the second answer more humanized.

It should be noted that the emotion recognition result shown in the above paragraph is obtained by analyzing the first speech, and the present disclosure does not limit the manner of obtaining the emotion recognition result. For example, the emotion recognition result may be obtained by using any method that may recognize an emotional state from speech. For another example, because ASR has an emotion recognition function, in some embodiments, the first text and the emotion recognition result are both obtained by performing speech recognition (such as ASR) on the first speech.

It may be learned based on the foregoing content of the server that the server may include the following features: (1) The server may provide some services, such as an interaction central control service, for the client. Specifically, after receiving the question text provided by the client, the server first performs FAQ retrieval judgment; if the question text meets a requirement for the FAQ retrieval, accurate answer matching is performed by means of information retrieval; meanwhile, the matched answer is transmitted to a subsequent processing module for processing; however, if the question text does not meet the requirement for the FAQ retrieval, the question text is input into the reply model for processing, and output data of the reply model is transmitted to the subsequent processing module for processing. (2) The server may perform drive signal summarization and data integration. Specifically, after obtaining a large amount of information from some processing modules, the server summarizes the information, so that the summary result includes a plurality of types of data, to provide the data to the client for rendering. (3) The server may also cooperate to implement the automatic broadcast function. Specifically, after the client sends a preset broadcast text (such as text such as copy and a script edited according to SSML rules) to the server, the server processes and feeds back the broadcast text (processing performed by the server shown in FIG. 6), so that the client may implement automatic virtual character broadcast based on the feedback.

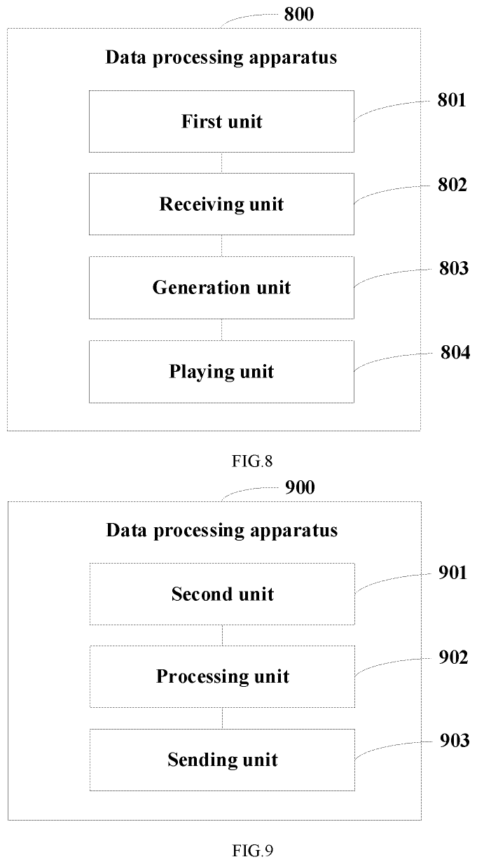

Based on the data processing method provided in embodiments of the present disclosure, an embodiment of the present disclosure further provides a data processing apparatus, which will be explained and described below with reference to FIG. 8. FIG. 8 is a schematic structural diagram of a data processing apparatus according to an embodiment of the present disclosure. For technical details of the data processing apparatus provided in the embodiment of the present disclosure, reference may be made to the foregoing content of the data processing method.

As shown in FIG. 8, the data processing apparatus 800 provided in the embodiment of the present disclosure includes:
a first unit 801 configured to receive a first speech, perform speech recognition on the first speech to obtain a first text, and send the first text to a server;
a receiving unit 802 configured to receive a second speech, an expression sequence, and an action sequence that are sent by the server, where the second speech indicates speech content of a virtual character when replying to the first speech, the expression sequence indicates expression changes of the virtual character when replying to the first speech, and the action sequence indicates action changes of the virtual character when replying to the first speech;
a generation unit 803 configured to generate an image sequence based on the expression sequence and the action sequence, where the image sequence describes changes of the virtual character in at least one dimension, and the at least one dimension includes an expression and/or an action; and a playing unit 804 configured to play the second speech and display the image sequence.

In some embodiments, the data processing apparatus 800 is deployed on a client; or the data processing apparatus 800 is independent of the client, and data communication may be performed between the data processing apparatus 800 and the client.

In some embodiments, the data processing apparatus 800 may be implemented by means of software or hardware (such as a circuit board).

In some embodiments, the client is a holographic cabin.

In some embodiments, the receiving unit 802 is further configured to: receive emotional information sent by the server, where the emotional information indicates an emotional state of the virtual character when replying to the first speech; and
the generation unit 803 is configured to: generate the image sequence based on the emotional information, the expression sequence, and the action sequence.

In some embodiments, the expression sequence indicates lip sync changes; and
the generation unit 803 is configured to: generate a face expression based on the emotional information, where the face expression indicates a face state of the virtual character when replying to the first speech other than a lip sync; and generate the image sequence based on the face expression, the expression sequence, and the action sequence.

In some embodiments, the emotional information includes a predicted probability of at least one candidate emotion; and
the generation unit 803 is configured to: determine a target emotion from the at least one candidate emotion based on the predicted probability of the at least one candidate emotion, where the predicted probability of the target emotion is not less than that of any emotion in the at least one candidate emotion other than the target emotion; and perform weighted fusion on an expression template corresponding to the target emotion and an expression template corresponding to a default emotion based on the predicted probability of the target emotion, to obtain the face expression, where the predicted probability of the target emotion indicates a weight corresponding to the expression template corresponding to the target emotion in the weighted fusion, the expression template corresponding to the target emotion indicates a face state under the target emotion, and the expression template corresponding to the default emotion indicates a face state under the default emotion.

In some embodiments, the client includes a state machine, and the state machine indicates a switching relationship of the virtual character between different states; and
the data processing apparatus 800 further includes: an updating unit configured to, update state information of the virtual character based on the state machine, where the updated state information indicates that the virtual character switches to a speaking state. In an embodiment, such updating operation by the updating unit may be performed after a second speech, the expression sequence, and the action sequence that are sent by the server are received.

In some embodiments, the image sequence is further generated based on at least one body feature corresponding to the updated state information, and the at least one body feature includes some or all of a blinking frequency, a head orientation, an eye orientation, and a body orientation.

In some embodiments, the first unit 801 is configured to: perform speech recognition on the first speech to obtain the first text in response to detecting that the first speech does not have a preset feature, where the preset feature indicates a feature of a speech replied by the virtual character in a broadcast manner; and
the first unit 801 is further configured to: send a text corresponding to the preset feature to the server in response to detecting that the first speech has the preset feature. In an embodiment, for example, such sending operation may be performed before a second speech, an expression sequence, and an action sequence that are sent by the server are received.

In some embodiments, the client includes a first database;
the first unit 801 is configured to: send the first text to the server in response to the first text not satisfying a retrieval condition of the first database; and
the first unit 801 is further configured to: in response to the first text satisfying the retrieval condition of the first database, send to the server a retrieval result of the first text in the first database. In an embodiment, for example, such sending operation may be performed before a second speech, an expression sequence, and an action sequence that are sent by the server are received.

In some embodiments, the receiving unit 802 is further configured to: receive a second text sent by the server, the action sequence includes an action prediction result predicted based on the second speech and an action matched from an action library based on the second text, the second text includes an insertion time of the matched action, the insertion time indicates a time when the virtual character presents the matched action, the image sequence includes an image corresponding to each frame of action in the action prediction result and an image corresponding to the matched action; and
the playing unit 804 is further configured to: during display of the image sequence, in response to playing the image corresponding to the matched action, determine whether a position indicated by the insertion time of the matched action in the second text is an end of a sentence, and if yes, skip the image corresponding to the matched action; if no, perform smoothing on the image corresponding to the matched action and an adjacent image of the image corresponding to the matched action in the image sequence to obtain a smoothed result of the image corresponding to the matched action and a smoothed result of the adjacent image, where the adjacent image includes a previous frame of image and/or a next frame of image, and sequentially play the smoothed result of the image corresponding to the matched action and the smoothed result of the next frame of image, where an arrangement position of the next frame of image in the image sequence is subsequent to that of the image corresponding to the matched action in the image sequence, and an arrangement position of the previous frame of image in the image sequence is prior to that of the image corresponding to the matched action in the image sequence.

It may be learned based on the foregoing content of the data processing apparatus 800 that the working principle of the apparatus 800 includes: after receiving the first speech (such as the speech describing the question from the user) input by the user, the apparatus 800 first performs speech recognition on the first speech to obtain the first text (such as the text describing the question from the user), and sends the first text to the server, so that the server may process and feed back the first text. Then, after receiving the second speech, the expression sequence, and the action sequence that are sent by the server, the apparatus 800 generates the image sequence based on the expression sequence and the action sequence, and the apparatus 800 plays the second speech and displays the image sequence, so that the apparatus 800 may automatically answer the question from the user, thereby reducing the cost of answering. The expression sequence may indicate expression changes of the virtual character when replying to the first speech, and the action sequence may indicate action changes of the virtual character when replying to the first speech, so that the image sequence generated based on the expression sequence and the action sequence may describe changes of the virtual character in at least one dimension (such as an expression and/or an action), thereby enabling the image sequence to represent changes (such as expression changes and action changes) presented by the virtual character when replying to the first speech. In addition, the second speech may indicate speech content of the virtual character when replying to the first speech, so that in the present disclosure, the virtual character can reply to the user with rich expression by playing the second speech and displaying the image sequence, thereby improving user experience.

Based on the data processing method provided in the embodiments of the present disclosure, an embodiment of the present disclosure further provides a data processing apparatus, which is explained and described below with reference to FIG. 9. FIG. 9 is a schematic diagram of a structure of another data processing apparatus according to an embodiment of the present disclosure. For technical details of the data processing apparatus provided in the embodiments of the present disclosure, reference may be made to the foregoing content of the data processing method.

As shown in FIG. 9, the data processing apparatus 900 provided in the embodiment of the present disclosure includes:
a second unit 901 configured to receive a first text sent by a client, determine a second text based on the first text, and generate a second speech based on the second text;
a processing unit 902 configured to determine an action sequence based on the second speech and the second text, and predict an expression sequence based on the second speech; and
a sending unit 903 configured to send the second speech, the expression sequence, and the action sequence to the client.

In some embodiments, the processing unit 902 is configured to: for any word in the second text, search a pre-built action library for an action matching the word to obtain a matching result for the word, and determine start and end times of an audio segment corresponding to the word from the second speech in response to the matching result indicating that there is an action in the action library that matches the word; and fuse the action matching the word and an action prediction result generated based on the second speech, to obtain the action sequence.

In some embodiments, the processing unit 902 is configured to: determine an insertion time of the action matching the word based on the start and end times; and in response to a position indicated by the insertion time of the action matching the word in the second text not being an end of a sentence, concatenate the action matching the word and the action prediction result based on the insertion time to obtain a concatenation result, and perform smoothing on the concatenation result to obtain the action sequence.

In some embodiments, the processing unit 902 is further configured to: predict emotional information based on the second speech and the second text;
the processing unit 902 is configured to: predict the expression sequence based on the emotional information and the second speech;
and/or
the sending unit 903 is configured to: send the emotional information, the second speech, the expression sequence, and the action sequence to the client.

In some embodiments, the server includes a second database; and
the second unit 901 is configured to: in response to the first text satisfying a retrieval condition of the second database, perform retrieval on the first text in the second database to obtain the second text; and additionally or alternatively, in response to the first text not satisfying the retrieval condition of the second database, input the first text into a pre-built reply model to obtain the second text output by the reply model.

In some embodiments, the first text indicates semantic content carried by a first speech;
the second unit 901 is further configured to: receive an emotion recognition result sent by the client, where the emotion recognition result indicates emotional information carried by the first speech; and
the second unit 901 is configured to: input the first text and the emotion recognition result into a pre-built reply model to obtain the second text output by the reply model.

It may be learned based on the foregoing content of the data processing apparatus 900 that the working principle of the apparatus 900 includes: after receiving the first text (such as the question text shown in FIG. 2) sent by the client, the apparatus 900 first determines the second text based on the first text, so that the second text may represent the reply content for the question indicated by the first text; and generates the second speech based on the second text, so that the second speech may represent the speech content used when the first text is replied to; then, the apparatus 900 determines the action sequence based on the second speech and the second text, so that the action sequence may represent action changes presented when the first text is replied to, and predicts the expression sequence based on the second speech, so that the expression sequence may represent expression changes presented when the first text is replied to; and finally, the apparatus 900 sends the second speech, the expression sequence, and the action sequence to the client for use, so that the client may reply to the first text with rich expression based on this information, thereby improving user experience. The action sequence and the expression sequence are both determined based on the second speech, so that both the action changes indicated by the action sequence and the action changes indicated by the expression sequence are highly correlated with the speech content indicated by the second speech, thereby enabling the virtual character presented when the client replies based on this information to present a better personified expression, which in turn helps to better improve user experience.

In addition, an embodiment of the present disclosure further provides an electronic device. The device includes a processor and a memory, where the memory is configured to store an instruction or a computer program, and the processor is configured to execute the instruction or the computer program in the memory to cause the electronic device to perform any implementation of the data processing method provided in the embodiments of the present disclosure.

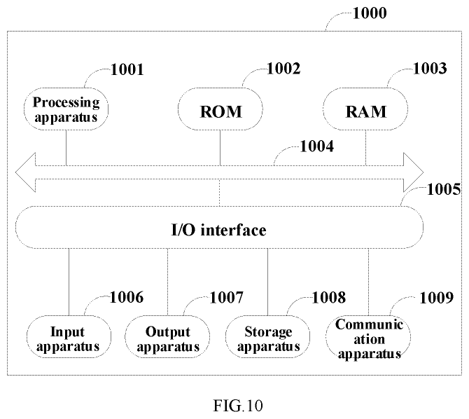

Referring to FIG. 10, it shows a schematic diagram of a structure of an electronic device 1000 suitable for implementing embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 10 is merely an example, and should not impose any limitation on the function and scope of use of the embodiments of the present disclosure.

As shown in FIG. 10, the electronic device 1000 may include a processing apparatus (such as a central processing unit and a graphics processing unit) 1001, which may perform various appropriate actions and processing according to a program stored in a read-only memory (ROM) 1002 or a program loaded from a storage apparatus 1008 into a random access memory (RAM) 1003. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a magnetic tape and a hard disk; and a communication apparatus 1009. The communication apparatus 1009 may allow the electronic device 1000 to perform wireless or wired communication with other devices to exchange data. Although FIG. 10 shows the electronic device 1000 having various apparatuses, it should be understood that not all the apparatuses shown herein need to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product including a computer program carried on a non-transitory computer-readable medium, the computer program including program code for performing the method shown in the flowchart. In such an embodiment, the computer program may be downloaded and installed from a network via the communication apparatus 1009, or installed from the storage apparatus 1008, or installed from the ROM 1002. When the computer program is executed by the processing apparatus 1001, the foregoing functions defined in the method of the embodiments of the present disclosure are performed.

The electronic device provided in the embodiments of the present disclosure belongs to the same inventive concept as the method provided in the foregoing embodiments. For technical details not described in detail in this embodiment, reference may be made to the foregoing embodiments, and this embodiment has the same beneficial effects as the foregoing embodiments.

An embodiment of the present disclosure further provides a computer-readable medium having an instruction or a computer program stored thereon, where the instruction or the computer program, when executed by a device, causes the device to perform any implementation of the data processing method provided in the embodiments of the present disclosure.

It should be noted that the foregoing computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in a plurality of forms, and includes, but is not limited to, an electromagnetic signal, an optical signal, or any suitable combination thereof. The computer-readable signal medium may alternatively be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to a wire, an optical cable, a radio frequency (RF), or any suitable combination thereof.

In some implementations, the client and the server may communicate using any currently known or future developed network protocol, such as the hyper text transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The foregoing computer-readable medium may be included in the foregoing electronic device, or may exist alone without being assembled into the electronic device.

The foregoing computer-readable medium carries one or more programs, and the one or more programs, when executed by the electronic device, cause the electronic device to perform the foregoing method.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by means of software, and may also be implemented by means of hardware. The name of the unit/module does not constitute a limitation on the unit itself under certain circumstances.

The foregoing functions described herein may be at least partially performed by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that the embodiments in this specification are described in a progressive manner. Each embodiment focuses on differences from other embodiments. For the same and similar parts between the embodiments, reference may be made to each other. For the system or apparatus disclosed in the embodiments, because it corresponds to the method disclosed in the embodiments, the description is relatively simple. For related parts, reference may be made to the description of the method.

It should be understood that in the present disclosure, “at least one item” means one or more, and “a plurality of” means two or more. “And/or” describes an association relationship between associated objects, and represents that three relationships may exist. For example, “A and/or B” may represent the following three cases: Only A exists, only B exists, and both A and B exist, where A and B may be singular or plural. The symbol “/” generally indicates an “or” relationship between the associated objects. At least one of the following items (pieces) “or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should be further noted that in this specification, relational terms such as first and second are used only to distinguish one entity or operation from another entity or operation, and do not necessarily require or imply any actual relationship or order between these entities or operations. Moreover, the terms “include”, “include”, or any other variant thereof are intended to cover non-exclusive inclusion, so that a process, method, object, or device that includes a list of elements includes not only those elements, but also other elements not explicitly listed or elements inherent to such a process, method, object, or device. Without further restrictions, an element defined by the phrase “includes a” does not exclude the existence of other identical elements in the process, method, object, or device that includes the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing description of the disclosed embodiments enables those skilled in the art to implement or use the present disclosure. Various modifications to these embodiments will be readily apparent to those skilled in the art, and the generic principles defined herein may be implemented in other embodiments without departing from the spirit or scope of the present disclosure. Therefore, the present disclosure is not limited to the embodiments shown herein, but is to be accorded the widest scope consistent with the principles and novel features disclosed herein.

What is claimed is:

1. A data processing method, wherein the method is implemented by a client, and the method comprises:
receiving a first speech, performing speech recognition on the first speech to obtain a first text, and sending the first text to a server;
receiving a second speech, an expression sequence, and an action sequence that are sent by the server, wherein the second speech indicates speech content of a virtual character when replying to the first speech, the expression sequence indicates expression changes of the virtual character when replying to the first speech, and the action sequence indicates action changes of the virtual character when replying to the first speech;
generating an image sequence based on the expression sequence and the action sequence, wherein the image sequence describes changes of the virtual character in at least one dimension, and the at least one dimension comprises at least one of an expression or an action; and
playing the second speech and displaying the image sequence.

2. The method of claim 1, wherein the client is a holographic cabin.

3. The method of claim 1, wherein the method further comprises:
receiving emotional information sent by the server, wherein the emotional information indicates an emotional state of the virtual character when replying to the first speech; and
the generating the image sequence based on the expression sequence and the action sequence comprises:
generating the image sequence based on the emotional information, the expression sequence, and the action sequence.

4. The method of claim 3, wherein the expression sequence indicates lip sync changes; and
the generating the image sequence based on the emotional information, the expression sequence, and the action sequence comprises:
generating a face expression based on the emotional information, wherein the face expression indicates a face state of the virtual character when replying to the first speech other than lip sync; and
generating the image sequence based on the face expression, the expression sequence, and the action sequence.

5. The method of claim 4, wherein the emotional information comprises a predicted probability of at least one candidate emotion; and
the generating the face expression based on the emotional information comprises:
determining a target emotion from the at least one candidate emotion based on the predicted probability of the at least one candidate emotion, wherein the predicted probability of the target emotion is not less than that of any emotion in the at least one candidate emotion other than the target emotion; and
performing weighted fusion on an expression template corresponding to the target emotion and an expression template corresponding to a default emotion based on the predicted probability of the target emotion, to obtain the face expression, wherein the predicted probability of the target emotion indicates a weight corresponding to the expression template corresponding to the target emotion in the weighted fusion, the expression template corresponding to the target emotion indicates a face state under the target emotion, and the expression template corresponding to the default emotion indicates a face state under the default emotion.

6. The method of claim 1, wherein the client comprises a state machine, and the state machine indicates a switching relationship of the virtual character between different states; and
wherein, the method further comprises:
updating state information of the virtual character based on the state machine, wherein the updated state information indicates that the virtual character switches to a speaking state.

7. The method of claim 6, wherein the image sequence is further generated based on at least one body feature corresponding to the updated state information, and the at least one body feature comprises some or all of a blinking frequency, a head orientation, an eye orientation, and a body orientation.

8. The method of claim 1, wherein the method further comprises:
in response to detecting an absence of a first feature in the first speech, performing speech recognition on the first speech to obtain the first text, wherein the first feature indicates a feature of a speech replied by the virtual character in a broadcast manner; or
in response to detecting that the first speech has the first feature, sending a text corresponding to the first feature to the server.

9. The method of claim 1, wherein the client comprises a first database;
and the method further comprises:
in response to the first text not satisfying a retrieval condition of the first database, sending the first text to the server; or
in response to the first text satisfying the retrieval condition of the first database, sending to the server a retrieval result of the first text in the first database.

10. An electronic device, wherein the device comprises: a processor and a memory;
the memory is configured to store an instruction or a computer program; and
the processor is configured to execute the instruction or the computer program in the memory to cause the electronic device to perform:
receiving a first speech, performing speech recognition on the first speech to obtain a first text, and sending the first text to a server;
receiving a second speech, an expression sequence, and an action sequence that are sent by the server, wherein the second speech indicates speech content of a virtual character when replying to the first speech, the expression sequence indicates expression changes of the virtual character when replying to the first speech, and the action sequence indicates action changes of the virtual character when replying to the first speech;
generating an image sequence based on the expression sequence and the action sequence, wherein the image sequence describes changes of the virtual character in at least one dimension, and the at least one dimension comprises at least one of an expression or an action; and
playing the second speech and displaying the image sequence.

11. The electronic device of claim 10, wherein the processor is configured to execute the instruction or the computer program in the memory to cause the electronic device to further perform:
receiving emotional information sent by the server, wherein the emotional information indicates an emotional state of the virtual character when replying to the first speech; and
the generating the image sequence based on the expression sequence and the action sequence comprises:
generating the image sequence based on the emotional information, the expression sequence, and the action sequence.

12. The electronic device of claim 11, wherein the expression sequence indicates lip sync changes; and
the generating the image sequence based on the emotional information, the expression sequence, and the action sequence comprises:
generating a face expression based on the emotional information, wherein the face expression indicates a face state of the virtual character when replying to the first speech other than lip sync; and
generating the image sequence based on the face expression, the expression sequence, and the action sequence.

13. The electronic device of claim 12, wherein the emotional information comprises a predicted probability of at least one candidate emotion; and
the generating the face expression based on the emotional information comprises:
determining a target emotion from the at least one candidate emotion based on the predicted probability of the at least one candidate emotion, wherein the predicted probability of the target emotion is not less than that of any emotion in the at least one candidate emotion other than the target emotion; and
performing weighted fusion on an expression template corresponding to the target emotion and an expression template corresponding to a default emotion based on the predicted probability of the target emotion, to obtain the face expression, wherein the predicted probability of the target emotion indicates a weight corresponding to the expression template corresponding to the target emotion in the weighted fusion, the expression template corresponding to the target emotion indicates a face state under the target emotion, and the expression template corresponding to the default emotion indicates a face state under the default emotion.

14. The electronic device of claim 10, wherein the client comprises a state machine, and the state machine indicates a switching relationship of the virtual character between different states; and
wherein the processor is configured to execute the instruction or the computer program in the memory to cause the electronic device to further perform:
updating state information of the virtual character based on the state machine, wherein the updated state information indicates that the virtual character switches to a speaking state.

15. The electronic device of claim 14, wherein the image sequence is further generated based on at least one body feature corresponding to the updated state information, and the at least one body feature comprises some or all of a blinking frequency, a head orientation, an eye orientation, and a body orientation.

16. The electronic device of claim 10, wherein the processor is configured to execute the instruction or the computer program in the memory to cause the electronic device to further perform:
in response to detecting an absence of a first feature in the first speech, performing speech recognition on the first speech to obtain the first text, wherein the first feature indicates a feature of a speech replied by the virtual character in a broadcast manner; or
in response to detecting that the first speech has the first feature, sending a text corresponding to the first feature to the server.

17. The electronic device of claim 10, wherein the client comprises a first database; and
wherein the processor is configured to execute the instruction or the computer program in the memory to cause the electronic device to further perform:
in response to the first text not satisfying a retrieval condition of the first database, sending the first text to the server; or
in response to the first text satisfying the retrieval condition of the first database, sending to the server a retrieval result of the first text in the first database.

18. A non-transitory computer-readable medium, wherein the non-transitory computer-readable medium has an instruction or a computer program stored thereon, wherein the instruction or the computer program, when executed by a device, causes the device to perform:
receiving a first speech, performing speech recognition on the first speech to obtain a first text, and sending the first text to a server;
receiving a second speech, an expression sequence, and an action sequence that are sent by the server, wherein the second speech indicates speech content of a virtual character when replying to the first speech, the expression sequence indicates expression changes of the virtual character when replying to the first speech, and the action sequence indicates action changes of the virtual character when replying to the first speech;
generating an image sequence based on the expression sequence and the action sequence, wherein the image sequence describes changes of the virtual character in at least one dimension, and the at least one dimension comprises at least one of an expression or an action; and
playing the second speech and displaying the image sequence.

19. The non-transitory computer-readable medium of claim 18, wherein the instruction or the computer program, when executed by a device, causes the device to further perform:
receiving emotional information sent by the server, wherein the emotional information indicates an emotional state of the virtual character when replying to the first speech; and
the generating the image sequence based on the expression sequence and the action sequence comprises:
generating the image sequence based on the emotional information, the expression sequence, and the action sequence.

20. The non-transitory computer-readable medium of claim 19, wherein the expression sequence indicates lip sync changes; and
the generating the image sequence based on the emotional information, the expression sequence, and the action sequence comprises:
generating a face expression based on the emotional information, wherein the face expression indicates a face state of the virtual character when replying to the first speech other than lip sync; and
generating the image sequence based on the face expression, the expression sequence, and the action sequence.
